(19) United States
(12) Patent Application Publication
(10) Pub. No.: US 2010/0253036 A1
(43) Pub. Date: Oct. 7, 2010

(54) Wheeled Vehicle that is Operated by Stepping Upward and Downward

(76) Inventors: Ping-Sheng Liu, Yongjing Shiang (TW); Wen-Chin Huang, Hemei Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/419,489

(22) Filed: Apr. 7, 2009

(51) Int. Cl. B62K 3/10

(52) U.S. Cl. 280/210

(57) ABSTRACT

A wheeled vehicle includes a main frame, a drive axle rotatably mounted on the main frame, a chainwheel secured on the drive axle, an eccentric shaft secured on the drive axle, a support post mounted on the main frame, a rocking arm pivotally mounted on the support post, and a linking member having an upper end pivotally connected with the rocking arm to move with the rocking arm and a lower end pivotally connected with the eccentric shaft to move the eccentric shaft. The rocking arm has two opposite sides each provided with a pedal. Thus, the wheeled vehicle is driven to move forward by stepping the pedals of the rocking arm upward and downward in a reciprocal manner to provide a different pedalling manner.

### BACKGROUND OF THE INVENTION

1. Field of the Invention

The present invention relates to a wheeled vehicle and, more particularly, to a wheeled vehicle that is like a bicycle and is used for leisure and fun to provide an amusement.

2. Description of the Related Art

A conventional wheeled vehicle, such as a bicycle, primarily comprises a main frame, a front wheel, a rear wheel, a chainwheel, a crank, two pedals, and a chain. Thus, when the two pedals are stepped forward and rearward in a cycling manner, the crank is driven by the two pedals to rotate the chainwheel which drives the chain which drives the rear wheel so that the wheeled vehicle is driven to move forward by stepping the pedals forward and rearward in a reciprocal manner. However, the two pedals are moved along a circular track, so that the riding manner of the wheeled vehicle is tedious and lacks novelty.

### BRIEF SUMMARY OF THE INVENTION

In accordance with the present invention, there is provided a wheeled vehicle, comprising a main frame, a drive axle rotatably mounted on the main frame, a chainwheel secured on the drive axle to rotate in concert with the drive axle, an eccentric shaft secured on the drive axle to drive and rotate the drive axle, a support post mounted on the main frame, a rocking arm pivotally mounted on the support post, and a linking member having an upper end pivotally connected with the rocking arm to move in concert with the rocking arm and a lower end pivotally connected with the eccentric shaft to drive and move the eccentric shaft relative to the drive axle. The rocking arm has two opposite sides each provided with a pedal protruding outwardly.

The primary objective of the present invention is to provide a wheeled vehicle that is operated by stepping upward and downward.

Another objective of the present invention is to provide a wheeled vehicle that is driven to move forward by stepping the pedals of the rocking arm upward and downward in a reciprocal manner to provide a different pedalling manner so as to enhance the amusement of riding the wheeled vehicle.

A further objective of the present invention is to provide a wheeled vehicle, wherein the seat tube and the handlebar stem are in turn folded onto the main frame so as to reduce the whole volume of the wheeled vehicle when not in use, thereby facilitating packaging, storage and transportation of the wheeled vehicle.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a wheeled vehicle in accordance with the preferred embodiment of the present invention.

FIG. 2 is a partially exploded perspective view of the wheeled vehicle as shown in FIG. 1.

FIG. 3 is a locally enlarged view of the wheeled vehicle as shown in FIG. 1.

FIG. 4 is a schematic front operational view of the wheeled vehicle as shown in FIG. 3.

FIG. 5 is a schematic side operational view of the wheeled vehicle as shown in FIG. 3.

FIG. 6 is a schematic operational view of the wheeled vehicle as shown in FIG. 5.

FIG. 7 is a schematic operational view of the wheeled vehicle as shown in FIG. 6.

FIG. 8 is a partially perspective folded view of the wheeled vehicle as shown in FIG. 1.

FIG. 9 is a partially perspective folded view of the wheeled vehicle as shown in FIG. 1.

FIG. 10 is a perspective folded view of the wheeled vehicle as shown in FIG. 1.

### DETAILED DESCRIPTION OF THE INVENTION

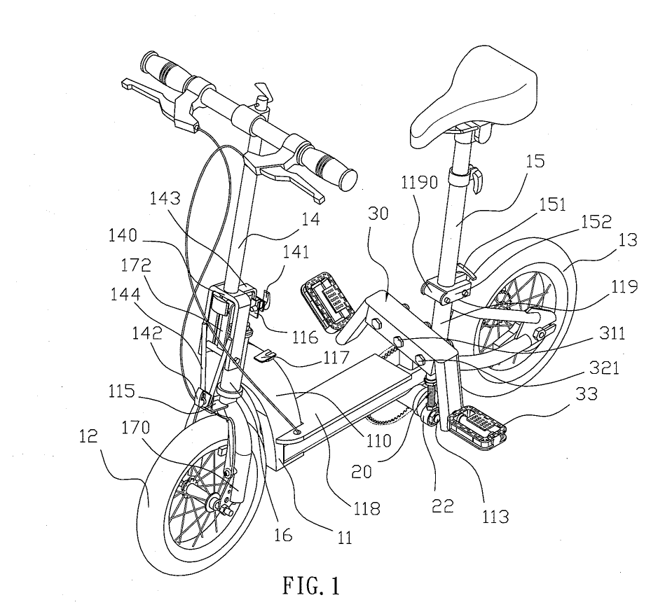

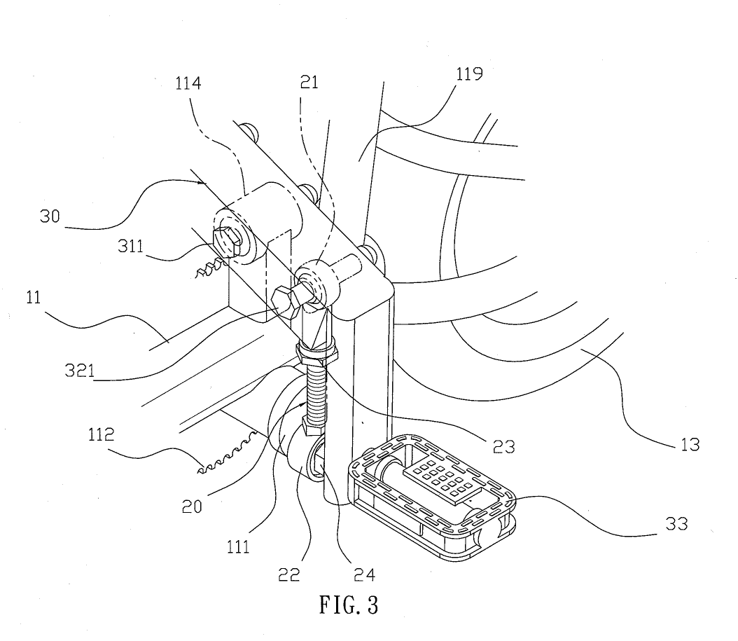

Referring to the drawings and initially to FIGS. 1-5, a wheeled vehicle in accordance with the preferred embodiment of the present invention comprises a main frame 11, a drive axle 111 rotatably mounted on the main frame 11, a chainwheel 112 secured on the drive axle 111 to rotate in concert with the drive axle 111, an eccentric shaft 113 secured on the drive axle 111 to drive and rotate the drive axle 111, a support post 114 mounted on the main frame 11, a rocking arm 30 pivotally mounted on the support post 114, and a linking member 20 having an upper end pivotally connected with the rocking arm 30 to move in concert with the rocking arm 30 and a lower end pivotally connected with the eccentric shaft 113 to drive and move the eccentric shaft 113 relative to the drive axle 111.

The chainwheel 112 and the eccentric shaft 113 are located at two opposite ends of the drive axle 111. The support post 114 is located above the drive axle 111.

The rocking arm 30 is located above the drive axle 111. The rocking arm 30 has a substantially inverted U-shaped profile and has two opposite sides each provided with a pedal 33 protruding outwardly. The rocking arm 30 has an axial direction parallel with that of the drive axle 111. The pedal 33 of the rocking arm 30 has an axial direction in line with that of the rocking arm 30. The rocking arm 30 has a middle position provided with a pivot portion 31 pivotally connected with the support post 114 by a pivot bolt 311. The rocking arm 30 has an end portion provided with a drive portion 32 located beside and spaced from the pivot portion 31.

The linking member 20 has a telescopically arranged structure and has a mediate portion provided with an adjusting nut 23. The upper end of the linking member 20 is provided with a driven head 21 pivotally connected with the drive portion 32 of the rocking arm 30 by a fastening bolt 321. The driven head 21 of the linking member 20 is preferably an universal connector. The lower end of the linking member 20 is provided with a drive head 22 pivotally connected with the drive axle 111 by a fastening nut 24. The drive head 22 of the linking member 20 is preferably a ring-shaped connector. The drive head 22 of the linking member 20 has an axial direction perpendicular to that of the driven head 21.

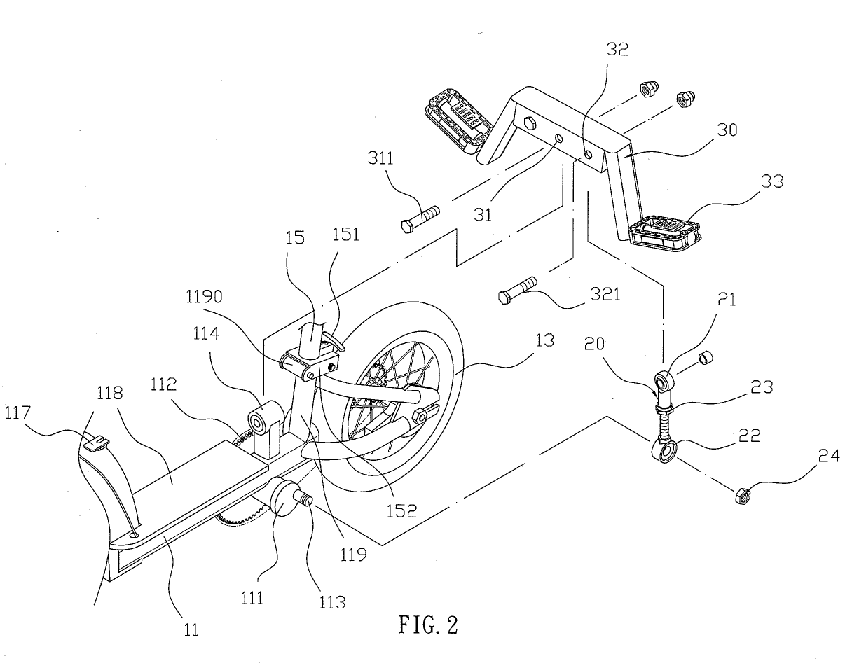

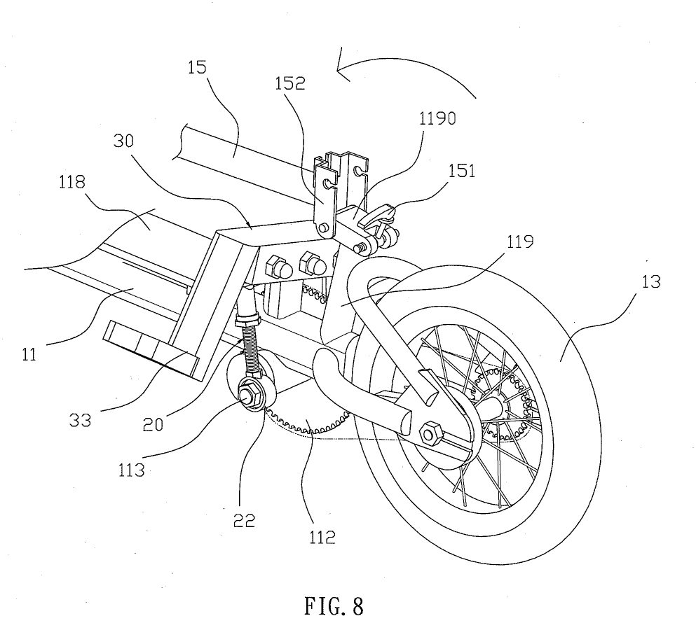

Referring to FIGS. 8-10 with reference to FIGS. 1 and 2, the wheeled vehicle further comprises a front wheel 12 mounted on a front end of the main frame 11, a rear wheel 13 mounted on a rear end of the main frame 11 and driven by the chainwheel 112, a tread board 118 mounted on the main frame 11 and located between the front wheel 12 and the rear wheel 13, a handlebar stem 14 pivotally and foldably mounted on the main frame 11, an upper fixing catch 116 mounted on the main frame 11, a lower fixing catch 117 mounted on the main frame 11 and located under the upper fixing catch 116, a locking lug 115 mounted on the main frame 11, a first quick release 141 pivotally mounted on the handlebar stem 14 and detachably locked onto the upper fixing catch 116 or the lower fixing catch 117, a second quick release 142 pivotally mounted on the handlebar stem 14 and detachably locked onto the locking lug 115, a seat tube 15 pivotally and foldably mounted on the main frame 11, and a third quick release 151 pivotally mounted on the main frame 11 and detachably locked onto the seat tube 15.

In the preferred embodiment of the present invention, the wheeled vehicle further comprises an extension rack 110 having a lower end mounted on the front end of the main frame 11, a head tube 16 mounted on an upper end of the extension rack 110, a steering tube 17 rotatably mounted in the head tube 16 and having an upper end provided with a support base 172 protruding outwardly from an upper end of the head tube 16 for mounting the handlebar stem 14 and a lower end provided with a fork crown 170 protruding outwardly from a lower end of the head tube 16 for mounting the front wheel 12, and a mounting post 119 mounted on the rear end of the main frame 11 for mounting the seat tube 15.

The handlebar stem 14 has a lower end provided with a pivot bracket 140 pivotally mounted on the support base 172 of the steering tube 17 to move in concert with the support base 172 of the steering tube 17. The upper fixing catch 116 is mounted on the upper end of the steering tube 17. The lower fixing catch 117 is mounted on the extension rack 110. The locking lug 115 is mounted on the fork crown 170 of the steering tube 17. The first quick release 141 is mounted on the pivot bracket 140 of the handlebar stem 14 by a bent fixing plate 143. The second quick release 142 is mounted on the pivot bracket 140 of the handlebar stem 14 by a fixing mount 144. The mounting post 119 has a lower end mounted on the rear end of the main frame 11 and an upper end provided with a support block 1190. The third quick release 151 is pivotally mounted on the support block 1190 of the mounting post 119. The seat tube 15 has a lower end provided with a fixing bracket 152 pivotally mounted on the support block 1190 of the mounting post 119 and releasably locked onto the support block 1190 of the mounting post 119 by the third quick release 151.

In assembly, the first quick release 141 is locked onto the upper fixing catch 116, and the second quick release 142 is locked onto the locking lug 115, so that the handlebar stem 14 is combined with the steering tube 17. In addition, the fixing bracket 152 of the seat tube 15 is locked onto the support block 1190 of the mounting post 119 by the third quick release 151 so that the seat tube 15 is combined with the mounting post 119.

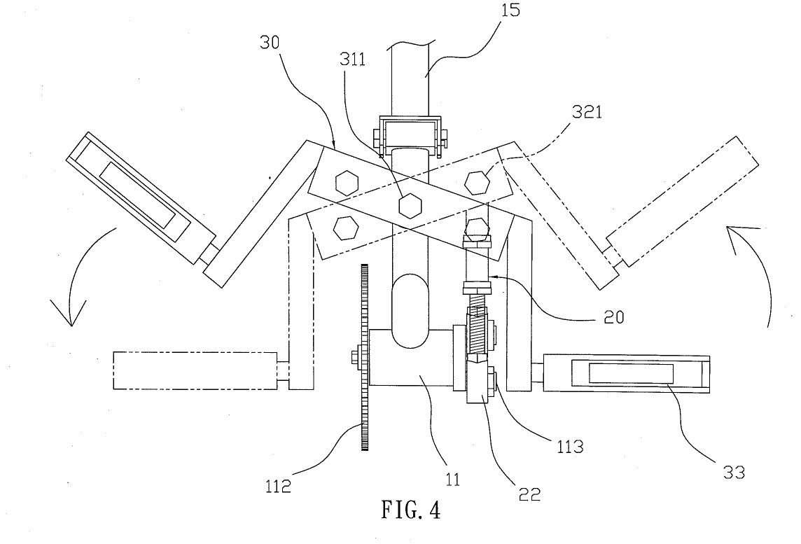

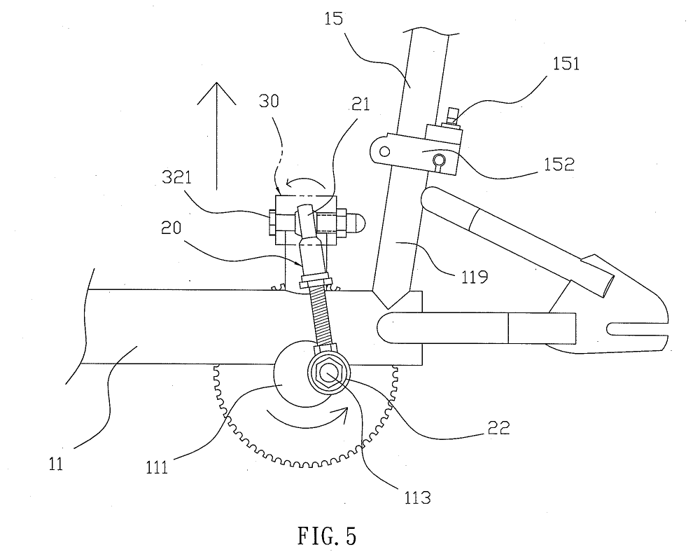

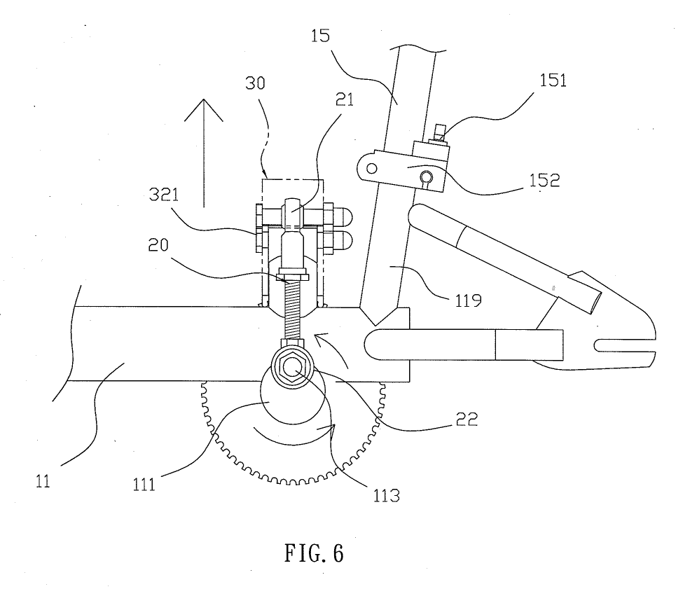

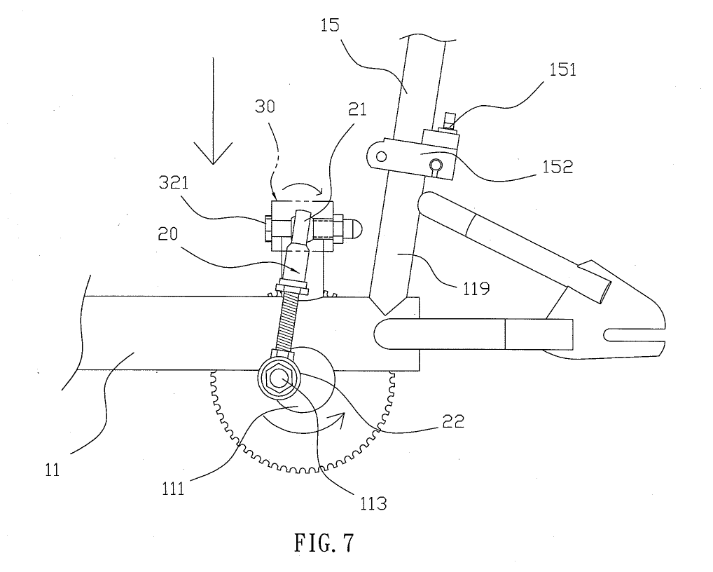

In operation, referring to FIGS. 4-7 with reference to FIGS. 1-3, when the pedals 33 on the two opposite sides of the rocking arm 30 are stepped upward and downward (as shown in FIG. 4), the pivot portion 31 of the rocking arm 30 is pivoted about the pivot bolt 311 to pivot the rocking arm 30 leftward and rightward which moves the drive portion 32 which moves the driven head 21 which moves the linking member 20 upward and downward which moves the drive head 22 which moves the eccentric shaft 113 (as shown in FIGS. 5-7) which eccentrically drives and rotates the drive axle 111 which rotates the chainwheel 112 which drives and rotates the rear wheel 13 so that the wheeled vehicle is driven to move forward by stepping the pedals 33 of the rocking arm 30 upward and downward in a reciprocal manner.

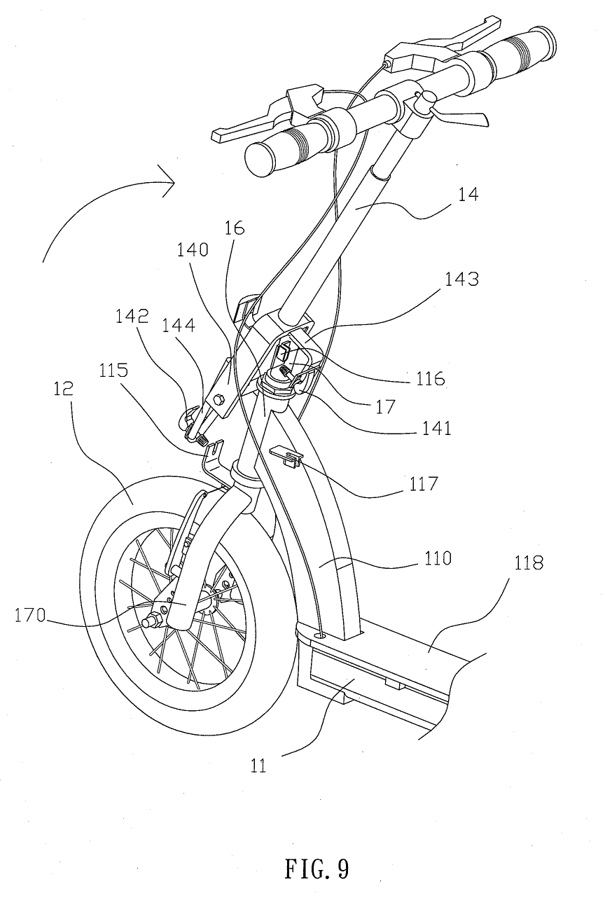

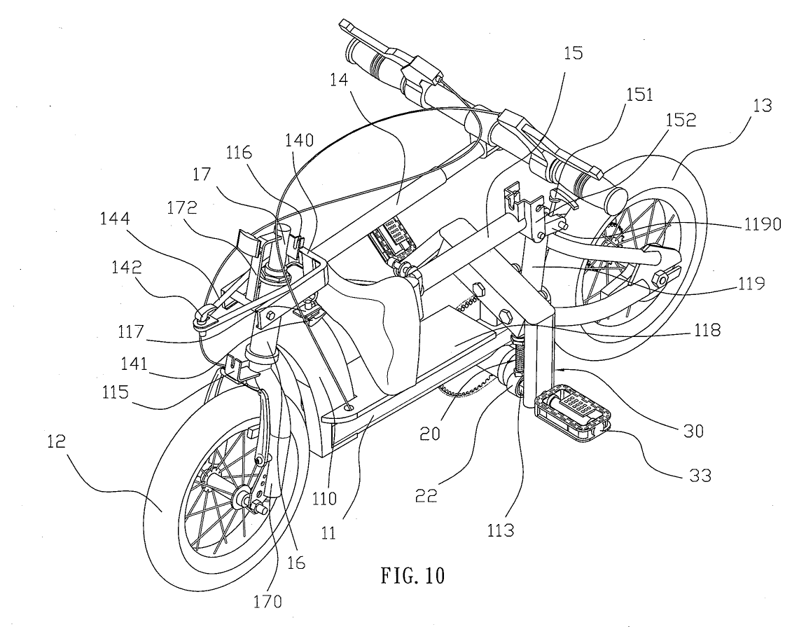

In folding of the wheeled vehicle, referring to FIGS. 8-10 with reference to FIGS. 1 and 2, the fixing bracket 152 of the seat tube 15 is unlocked from the support block 1190 of the mounting post 119 by releasing the third quick release 151 as shown in FIG. 8 so that the seat tube 15 is unlocked from the mounting post 119 and can be pivoted forward toward the front wheel 12. Then, the first quick release 141 is unlocked from the upper fixing catch 116, and the second quick release 142 is unlocked from the locking lug 115 as shown in FIG. 9, so that the handlebar stem 14 is unlocked from the steering tube 17 and can be pivoted backward toward the rear wheel 13. In such a manner, the seat tube 15 and the handlebar stem 14 are in turn folded onto the main frame 11 as shown in FIG. 10 so as to reduce the whole volume of the wheeled vehicle when not in use. At this time, the first quick release 141 is locked onto the lower fixing catch 117 so that the handlebar stem 14 is locked onto the main frame 11.

Accordingly, the wheeled vehicle is driven to move forward by stepping the pedals 33 of the rocking arm 30 upward and downward in a reciprocal manner to provide a different pedalling manner so as to enhance the amusement of riding the wheeled vehicle. In addition, the seat tube 15 and the handlebar stem 14 are in turn folded onto the main frame 11 so as to reduce the whole volume of the wheeled vehicle when not in use, thereby facilitating packaging, storage and transportation of the wheeled vehicle.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wheeled vehicle, comprising:
a main frame;
a drive axle rotatably mounted on the main frame;
a chainwheel secured on the drive axle to rotate in concert with the drive axle;
an eccentric shaft secured on the drive axle to drive and rotate the drive axle;
a support post mounted on the main frame;
a rocking arm pivotally mounted on the support post;
a linking member having an upper end pivotally connected with the rocking arm to move in concert with the rocking arm and a lower end pivotally connected with the eccentric shaft to drive and move the eccentric shaft relative to the drive axle.

2. The wheeled vehicle of claim 1, wherein the rocking arm has a middle position provided with a pivot portion pivotally connected with the support post by a pivot bolt.

3. The wheeled vehicle of claim 2, wherein
the rocking arm has an end portion provided with a drive portion located beside and spaced from the pivot portion;
the upper end of the linking member is provided with a driven head pivotally connected with the drive portion of the rocking arm by a fastening bolt.

4. The wheeled vehicle of claim 3, wherein the lower end of the linking member is provided with a drive head pivotally connected with the drive axle.

5. The wheeled vehicle of claim 1, wherein the rocking arm has two opposite sides each provided with a pedal protruding outwardly.

6. The wheeled vehicle of claim 4, wherein the drive head of the linking member has an axial direction perpendicular to that of the driven head.

7. The wheeled vehicle of claim 1, further comprising:
a handlebar stem pivotally and foldably mounted on the main frame;
an upper fixing catch mounted on the main frame;
a lower fixing catch mounted on the main frame and located under the upper fixing catch;
a locking lug mounted on the main frame;
a first quick release pivotally mounted on the handlebar stem and detachably locked onto the upper fixing catch or the lower fixing catch;
a second quick release pivotally mounted on the handlebar stem and detachably locked onto the locking lug.

8. The wheeled vehicle of claim 7, further comprising:
a seat tube pivotally and foldably mounted on the main frame;
a third quick release pivotally mounted on the main frame and detachably locked onto the seat tube.

9. The wheeled vehicle of claim 8, further comprising:
a front wheel mounted on a front end of the main frame;
a rear wheel mounted on a rear end of the main frame and driven by the chainwheel;
a tread board mounted on the main frame and located between the front wheel and the rear wheel.

10. The wheeled vehicle of claim 9, further comprising:
an extension rack having a lower end mounted on the front end of the main frame;
a head tube mounted on an upper end of the extension rack;
a steering tube rotatably mounted in the head tube and having an upper end provided with a support base protruding outwardly from an upper end of the head tube for mounting the handlebar stem and a lower end provided with a fork crown protruding outwardly from a lower end of the head tube for mounting the front wheel;
a mounting post mounted on the rear end of the main frame for mounting the seat tube.

11. The wheeled vehicle of claim 10, wherein
the handlebar stem has a lower end provided with a pivot bracket pivotally mounted on the support base of the steering tube to move in concert with the support base of the steering tube;
the upper fixing catch is mounted on the upper end of the steering tube;
the lower fixing catch is mounted on the extension rack;
the locking lug is mounted on the fork crown of the steering tube;
the first quick release is mounted on the pivot bracket of the handlebar stem by a bent fixing plate;
the second quick release is mounted on the pivot bracket of the handlebar stem by a fixing mount.

12. The wheeled vehicle of claim 10, wherein
the mounting post has a lower end mounted on the rear end of the main frame and an upper end provided with a support block;
the third quick release is pivotally mounted on the support block of the mounting post;
the seat tube has a lower end provided with a fixing bracket pivotally mounted on the support block of the mounting post and releasably locked onto the support block of the mounting post by the third quick release.

13. The wheeled vehicle of claim 8, wherein
the seat tube is pivotable forward toward the front wheel.
the handlebar stem is pivotable backward toward the rear wheel.

14. The wheeled vehicle of claim 5, wherein the rocking arm has a substantially inverted U-shaped profile;

15. The wheeled vehicle of claim 1, wherein the chainwheel and the eccentric shaft are located at two opposite ends of the drive axle.

16. The wheeled vehicle of claim 1, wherein
the support post is located above the drive axle;
the rocking arm is located above the drive axle.

17. The wheeled vehicle of claim 1, wherein the rocking arm has an axial direction parallel with that of the drive axle.

18. The wheeled vehicle of claim 5, wherein the pedal of the rocking arm has an axial direction in line with that of the rocking arm.
